(19) United States
(12) Patent Application Publication
(10) Pub. No.: US 2015/0309577 A1
(43) Pub. Date: Oct. 29, 2015

(54) REMOTE CONTROL DEVICE, DISPLAY SYSTEM AND ASSOCIATED DISPLAY METHOD

(71) Applicant: BENQ CORPORATION, Taipei (TW)

(72) Inventors: Lin-Yuan You, Taipei City (TW); Tzu-Pang Chiang, Taoyuan County (TW)

(73) Assignee: BENQ CORPORATION, Taipei (TW)

(21) Appl. No.: 14/795,885

(22) Filed: Jul. 9, 2015

Related U.S. Application Data
(63) Continuation of application No. 14/016,325, filed on Sep. 3, 2013.

(30) Foreign Application Priority Data
Sep. 7, 2012 (TW) 101132668

(51) Int. Cl. G06F 3/01; G06F 3/0354; G09G 5/10; G06F 3/0484; G06F 3/042; G06F 3/0346; G06F 3/038

(52) U.S. Cl. CPC G06F 3/016; G06F 3/0346; G06F 3/03542; G06F 3/03545; G06F 3/0386; G06F 3/0484; G06F 3/042; G09G 5/10; G09G 2320/0606; G09G 2320/0626

(57) ABSTRACT

A display system, a remote control device, and a display method are provided. The display system includes the remote control device and a display device. The display method includes following steps. The remote control device generates a vibration signal of housing by sensing an acceleration of a movement of the housing in a space. The remote control device transmits the vibration signal of housing to the display device. The display device displays a display image. In the display image, the indication path is pointed to an intersection position. An indication pattern is displayed at the intersection position, wherein an appearance of the indication pattern changes according to a number of times that the vibration signal of housing is received.

This application is a continuation application of U.S. application Ser. No. 14/016,325, filed Sep. 3, 2013, which claims the benefit of Taiwan application Serial No. 101132668, filed Sep. 7, 2012, the contents of which are incorporated herein by reference.

### BACKGROUND OF THE INVENTION

1. Field of the Invention

The invention relates in general to a remote control device, a display system and associated display method, and more particularly, to a remote control device, a display system and associated display method that adjust a display image according to a movement amount of indicator and a movement direction of indicator.

2. Description of the Related Art

Accompanied with the prevalence of electronic whiteboards and interactive projectors, technologies of optical pens for presenting a mouse cursor also continue to progress. Among the different trace sensing methods, basis for trace sensing methods of an optical pen may be categorized into two types—an image signal including coordinate information and an image signal excluding coordinate information.

In the type of an image signal excluding coordinate information, an optical pen generates an indication point on a screen purely in response to a user operation. Then, a position device disposed near the screen detects a coordinate position of the indication point. In the type of an image signal including coordinate information, an optical pen is capable of reading coordinate information carried in the image signal. Hence, coordinate position of a current indication point in a display image can be accordingly determined.

FIG. 1A shows a schematic diagram of a conventional display system based on the “image signal excluding coordinate information” technology. Also refer to U.S. Pat. No. 5,528,263, “Interactive Projected Video Image Display System”. In FIG. 1A, a display system 13 is provided with associated sensing devices 111 around a projection screen 11. An optical pen 10, being operated by a user, controls a projector 112 to generate an indication point on the projection screen 11. The sensing devices 111 then feedback a position of the indication point back to a computer host 12.

Under the above architecture, when detecting trace of an optical trace using the technology based on an image signal excluding coordinate information, sensed coordinates of the sensing devices 111 need to be consistent with display coordinates of a projected image of the projector 112. Otherwise, the display coordinates in the projected image of the projector 14 may not be equivalent to the sensed coordinates. For instance, the sensing devices 111 accurately sense the sensed coordinates of the indication point as (X.Y), but an indication point of a mouse cursor may be presented at a different position on the projection screen 11. As such, the optical pen 10 may be interpreted as being malfunctioning.

In other words, when sensing an input trace of the optical pen using the technology based on an image signal excluding coordinate information, a calibration procedure on the sensing devices 111 and the projector 12 is required whenever relative positions of the sensing devices 111, the projection screen 11 and the projector 14 change. For example, the sensing devices 111 and the projector 14 are relocated from a classroom A and rearranged in a conference room B. The calibration procedure for adjusting corresponding relationship between display coordinates and sensed coordinates leads to usage restriction and inconveniences.

FIG. 1B shows a schematic diagram of a conventional display system based on the “image signal including coordinate information” technology. Also refer to the U.S. Pat. No. 7,421,111, “Light pen System for Pixel-Based Displays”. A computer host 16 first controls a projection device 14 to sequentially and alternately project a user image signal image and a sequence of coordinate patterns on a predetermined display region. For example, in every second, 59 frames of the user image signal are projected, and one frame of the coordinate patterns is inserted and projected. With an extremely low ratio of insertion, the sequence of coordinate patterns is inserted among the image signal images played by the user, and so the user does not perceive any image difference by naked eyes.

As such, by inserting the sequence of coordinate patterns at the timing of the 60^{th} frame, each position on the display image is given a unique sequence of light intensity. Therefore, the sequence of the unique sequence of light intensity corresponding to a specified position in the display region is detected once every 60 frames. Consequentially, a corresponding code representing a position of an indication point currently pointed by the optical pen point can be retrieved. Further, in the display region, the position of the indication point of an optical pen 15 can be determined according to the sequence of light intensity.

For example, the coordinate patterns are designed and presented by the display image with a shadow at different corner. For instance, a shadow at an upper-left block at a first time point t1 (the timing of the 60^{th} frame), a shadow at an upper-right block at a second time point t2 (the timing of the 120^{th} frame), a shadow at a lower-right block at a third time point t3 (the timing of the 180^{th} frame), and a shadow at a lower-left block at a fourth time point t4 (the timing of the 240^{th} frame) are shown in FIG. 1B.

As such, when the code sequence sensed by the optical pen 15 at the first time point t1, the second time point t2, the third time pint t3, and the fourth time point t4 is (1, 0, 0, 0), it can be determined that the position of the current indication point is at the upper-left block of the display image. Similarly, when the code sequence is (0, 1, 0, 0), it can be determined that the position of the current indication point is aligned with the upper-right block of the display image.

Since the image of the coordinate patterns and the user image signal are both projected by the projection device 14, a display system 17 in FIG. 1B can be directly utilized without first carrying out a calibration process when it is relocated and rearranged.

A display image to be described below is applicable to display systems that either implements an image signal including or excluding coordinate information. For illustration purposes, whether an image signal includes coordinate information is not specified below.

FIG. 2A shows a schematic diagram of a cross-shaped cursor representing an indication point of an optical pen. In the display image, a position on a display image 22 being pointed by the optical pen 21 is defined as the intersection position. And, a cursor 23 is used to notify the user about the intersection position. When a user moves the optical pen 21, position of the cursor 23 in the display image 22 also correspondingly changes.

Referring to FIG. 2B, the display system also provides a writing function. When the writing function is activated by a user, a movement path of the optical pen 21 becomes an input trace 26 entered by the user.

In FIG. 2B, the prior art provides merely displaying an input trace of the optical pen. However, the optical pen itself does not provide any options for changing display attributes of the input trace. In order to update a color or a width of the input trace, the user needs to select a palette setting in the display image 22 for further setting adjustments. That is to say, if the user wishes to draw or write with multiple colors, the user is required to repeatedly activate the palette function and reselect a newly desired color setting for the input trace. Such process is trivial and user-unfriendly.

Further, when the user needs to adjust the display image 22 in a display window, adjustments with respect to a vertical scroll 24 and a horizontal scroll 25 in the display image 22 are usually required. Thus, the above horizontal or vertical adjustments on the display image 22 involve additional control means such as a mouse or a touch pad that is connected to a computer host. Consequently, the user is mandated to alternately utilize the optical pen and the touch pad/mouse in order to successfully perform the process of drawing or writing.

### SUMMARY OF THE INVENTION

According to an aspect of the present invention, a display method applied between a remote control device and a display device that are in communication with each other is provided. The display method comprises the following steps. The remote control device generates a vibration signal of housing by sensing an acceleration of a movement of the housing in a space. The remote control device transmits the vibration signal of housing to the display device. The display device displays a display image. In the display image, the indication path is pointed to an intersection position, and an indication pattern is displayed at the intersection position. An appearance of the indication pattern changes according to a number of times that the vibration signal of housing is received.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1A (prior art) is a schematic diagram of a conventional display system based on an image signal excluding coordinate information of the prior art for sensing an indication point of an optical pen;

FIG. 1B (prior art) is a schematic diagram of a conventional display system based on an image signal including coordinate information of the prior art for sensing an indication point of an optical pen;

FIG. 2A (prior art) is a schematic diagram of a cross-shaped cursor representing an indication point of an optical pen;

FIG. 2B (prior art) is a schematic diagram of displaying an input trace in a display image in response to a movement of an optical pen;

FIG. 3A is a schematic diagram of an optical pen according to an embodiment of the present invention;

FIG. 3B is an internal block diagram of an optical pen according to an embodiment of the present invention;

FIG. 3C is a schematic diagram of representing a placement of an optical pen using a horizontal included angle at long-axis;

FIG. 4 is a schematic diagram of a display device according to an embodiment of the present invention;

FIG. 5 is a flowchart of adjusting a display image using an optical pen according to a first embodiment of the present invention;

FIGS. 6A, 6B and 6C are schematic diagrams of a display device vertically adjusting a display image;

FIGS. 7A, 7B and 7C are schematic diagrams of a display device horizontally adjusting a display image;

FIG. 8A is a schematic diagram of an indication path of an optical pen pointing towards a display image;

FIG. 8B is a schematic diagram of an indication path of an optical pen not pointing towards a display image;

FIG. 9 is a flowchart of adjusting a display image using an optical pen according to a second embodiment of the present invention;

FIGS. 10A, 10B and 10C are schematic diagram of a display device controlling a display image to perform a scaling adjustment;

FIGS. 11A and 11B are schematic diagrams illustrating correlation between a horizontal included angle at long-axis and a display image adjustment method;

FIG. 12A is a schematic diagram of representing a placement of an optical pen using a horizontal included angle at lateral-axis;

FIG. 12B is a schematic diagram illustrating correlation between a horizontal included angle at lateral-axis and a display image adjustment method;

FIG. 13A is a schematic diagram of an optical pen utilizing a long touch panel as an input unit;

FIG. 13B is a schematic diagram of an optical pen utilizing a rocker as an input unit;

FIG. 13C is a schematic diagram of an optical pen utilizing a key switch as an input unit;

FIG. 14 is a schematic diagram of a display system according to an embodiment of the present invention;

FIG. 15A is a schematic diagram of several preselected brush stroke patterns provided by a display device;

FIG. 15B is a schematic diagram of several candidate colors provided for setting display attributes of the input trace of the optical pen;

FIG. 16 is a schematic diagram of a display image changing a trace color according to a dynamic operation of the optical pen performed by a user;

FIG. 17A is a schematic diagram of a display system in a non-writing mode;

FIG. 17B is a schematic diagram of a display system in a writing mode;

FIG. 18 is a schematic diagram of sensing a rotation range of an optical pen;

FIG. 19 is a schematic diagram of the optical pen being rotated by the user;

FIG. 20A is a schematic diagram of representing different corresponding widths of an input trace by rotating the optical pen;

FIG. 20B is a cross-section of the optical pen corresponding to different time points during a writing process in FIG. 20A; and,

FIG. 21 is a schematic diagram of different placements of an optical pen corresponding to changes in a vertical included angle and in an input trace width.

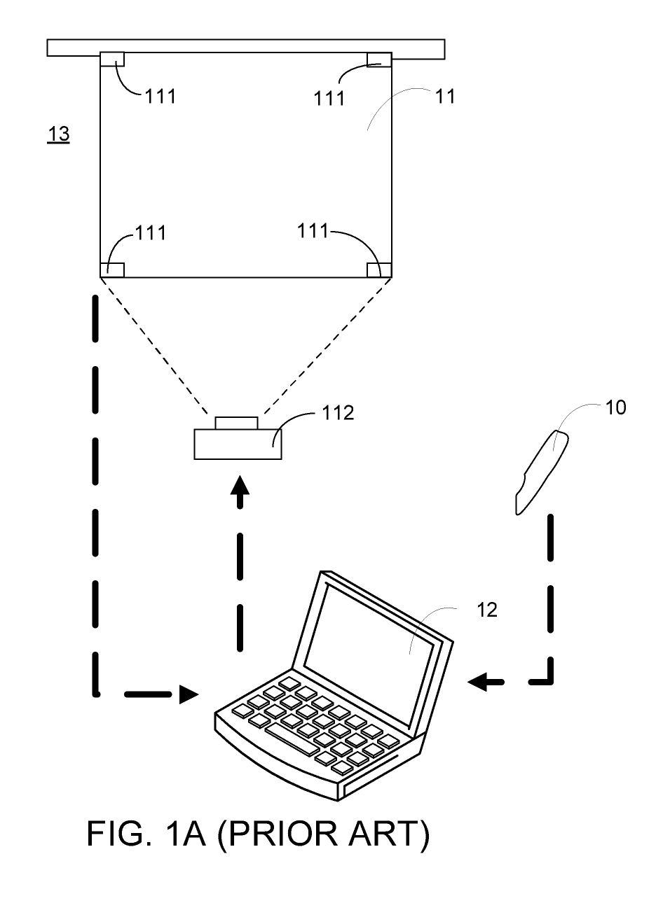

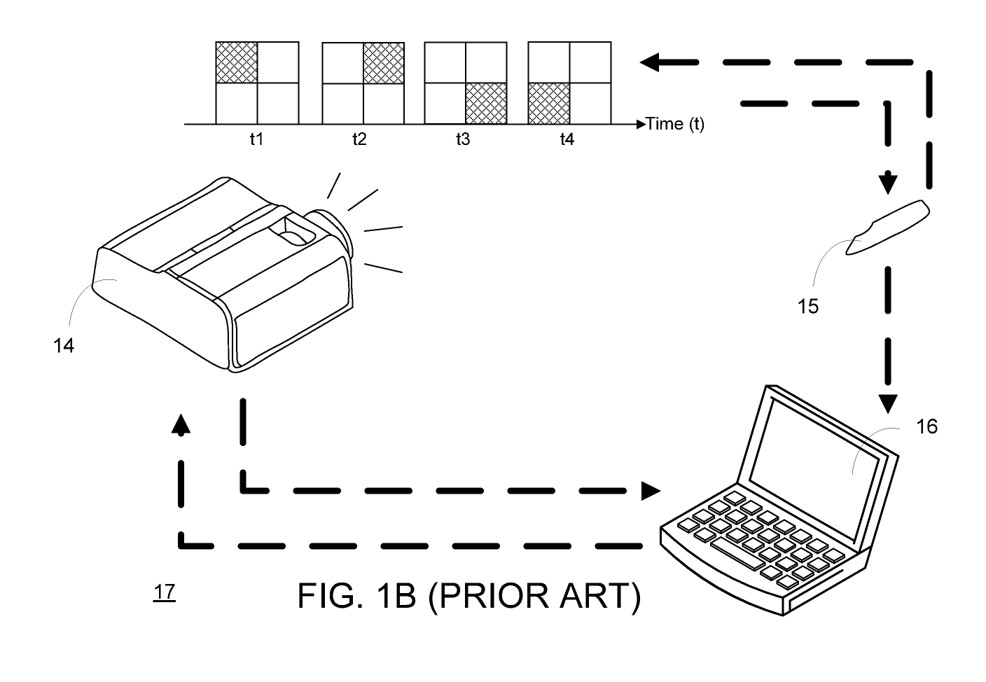

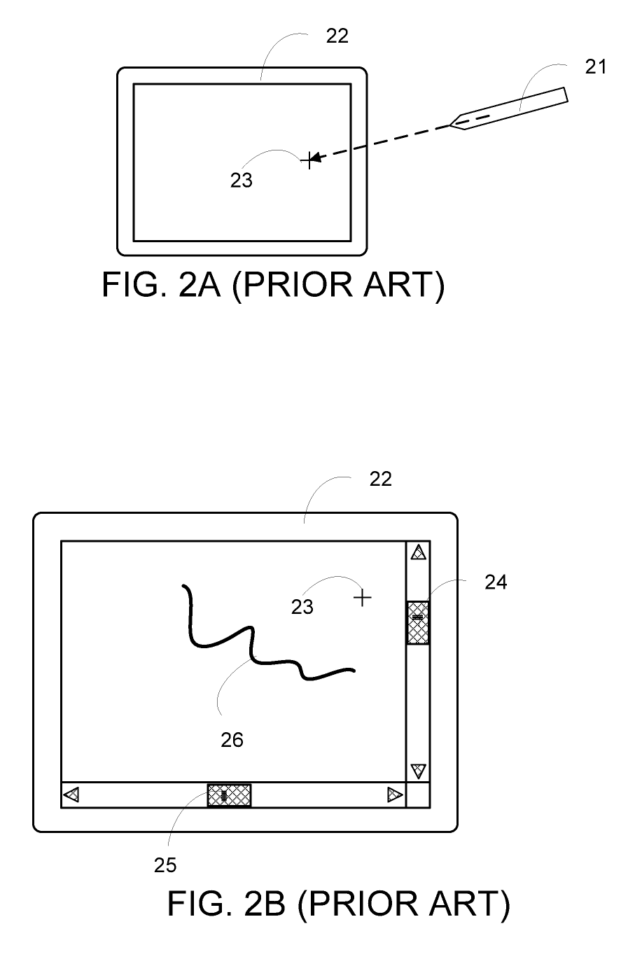

### DETAILED DESCRIPTION OF THE INVENTION

According to an embodiment of the present invention, a display image is directly adjusted by a remote control device. For example, a vertical scroll of the display image, a horizontal scroll of the display image, and a scaling ratio of the display image are adjusted. Further, when drawing with an optical pen of the present invention, a width, brightness level and colors of an input trace of the optical pen can be directly controlled. For illustration purposes, an example of an optical pen utilized as a remote control device is given for explaining the embodiments. It should be noted that in practical application, type of the remote control device is unlimited.

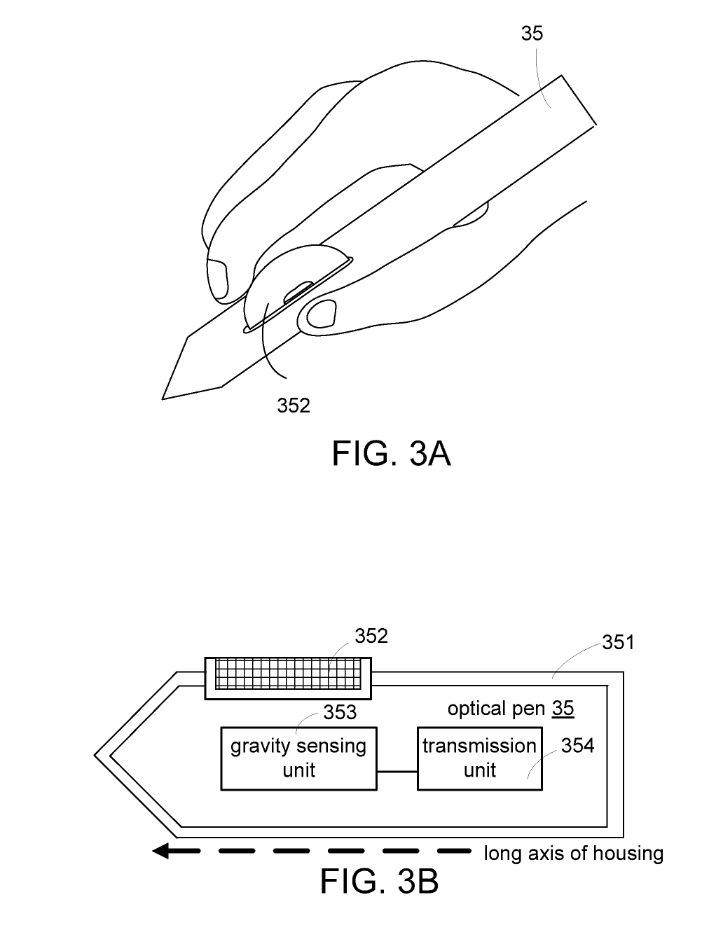

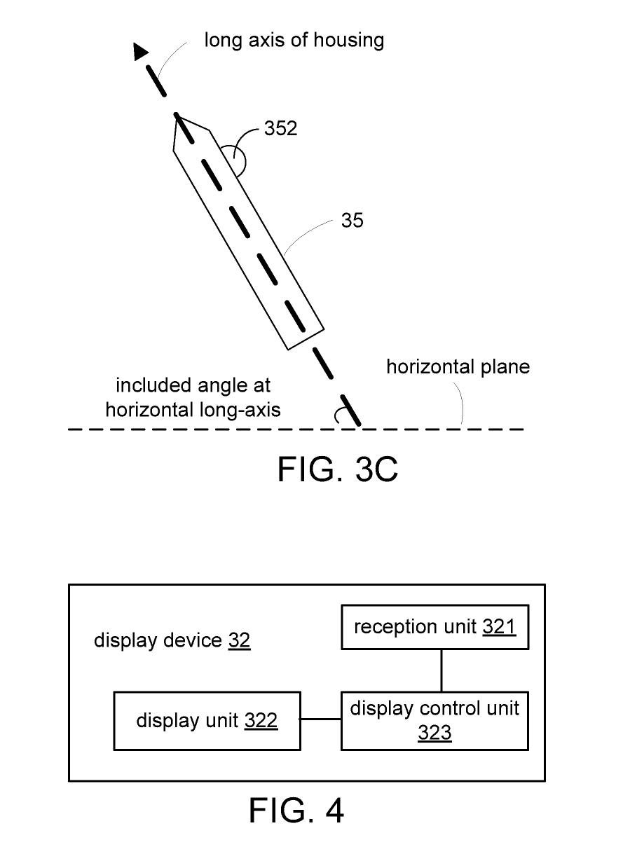

FIG. 3A shows a schematic diagram of an optical pen according to an embodiment of the present invention. An optical pen 35 includes a roller 352 disposed at its housing and near a pen point. With such placement, a user is able to operate/turn the roller 352 at the same time when holding the optical pen 35. Further, by manually controlling and changing a placement of the optical pen 35 and turning the roller 352, the user is enabled to perform various types of adjustments on a display image through these operations. Associated details are given below.

FIG. 3B shows an internal block diagram of an optical pen according to an embodiment of the present invention. The optical pen 35 includes a pen-like housing 351, a roller 352, a gravity sensing unit 353, and a transmission unit 354. The gravity sensing unit 353 and the transmission unit 354 are both disposed in the housing 351. The roller 352 is disposed at a surface of the pen-like housing 351. Further, the transmission unit 354 is electrically connected to the gravity sensing unit 353 and the roller 352.

The roller 352 may be regarded as an input unit, and generate movement information of indicator (A) according to a rotation amount and a rotation direction. The gravity sensing unit 353 generates placement information (B) according to placement of the pen-like housing 351. Through transmission means such as Bluetooth or wireless networks, the transmission unit 354 outputs the movement information of indicator (A) and the placement information (B).

FIG. 3C shows a schematic diagram of representing a placement of an optical pen by a horizontal included angle at long-axis.

In an embodiment of the present invention, a direction of a pen body from a tail to the pen point of the optical pen 35 is defined as a long axis of the housing, and an extended direction of the long axis of the housing is further defined as an indication path. Besides, a horizontal included angle at long-axis is defined as an included angle between the long axis of the housing and a horizontal plane. When the user holds the optical pen 35 and controls the placement of the optical pen 35, the direction of the pen body of the optical pen 35 changes, and this leads to a change in the horizontal included angle at long-axis.

Thus, the gravity sensing unit 353 may utilize the horizontal included angle at long-axis to represent the placement information (B). Further, the roller 352 is rotated according to the user control to generate the movement information of indicator (A) including a movement direction of indicator (a1) and a movement amount of indicator (a2).

FIG. 4 shows a schematic diagram of a display device according to an embodiment of the present invention. According to a concept of the present invention, the display device may be an electronic whiteboard based on an image signal excluding coordinate information, or a projection device based on an image signal including coordinate information. Alternatively, the display device may also be a projection screen supporting an indication sensing function, a liquid-crystal display (LCD) panel, or a screen of a tablet computer or a laptop computer.

A display device 32 includes a reception unit 321, a display control unit 323, and a display unit 322. The reception unit 321 is in communication with the transmission unit of the remote control device, and the display control unit 323 is electrically connected to the reception unit 321 and the display unit 322.

After the reception unit 321 receives the movement information of indicator (A) and the placement information (B), the display control unit 323 adjusts the display image presented by the display unit 322 according to the movement information of indicator (A) and the placement information (B).

The display device 32 may further include a storage unit (not shown) electrically connected to the display unit 322. When the display device 32 is utilized with graphics software, with the storage unit, the display device 32 may store position changes of an input trace, and settings of display attributes such as size, width, color and brightness level settings of the input trace.

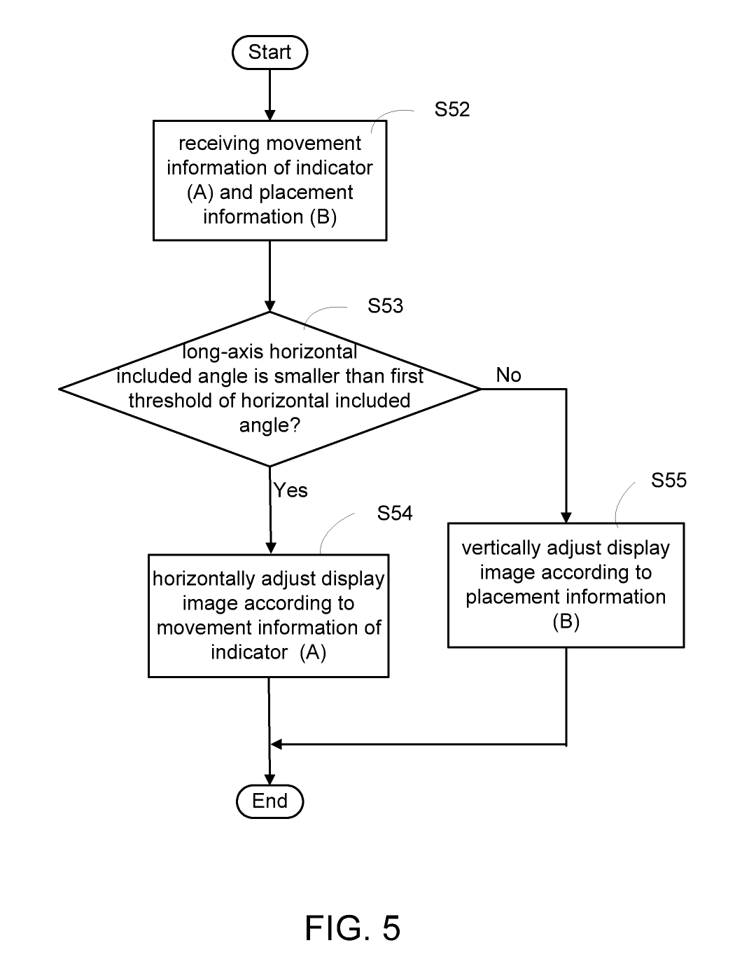

FIG. 5 shows a flowchart of a process for adjusting a display image using an optical pen according to a first embodiment of the present invention. In step S52, a display device receives movement information of indicator (A) and placement information (B) outputted by the optical pen. In step S53, whether the horizontal included angle at long-axis is smaller than a first threshold of horizontal included angle is determined. That is, a determination step according to the horizontal included angle at long-axis represented by the placement information (B) is performed.

When a determination result of step S53 is negative, the display device vertically moves the display image according to the movement information of indicator (A) in step S55. For example, the display image is controlled for vertical scroll up/down. Conversely, when the determination result of step S53 is positive, the display device horizontally adjusts the display image according to the movement information of indicator (A) in step S54. For example, the display image is controlled for horizontal scroll right/left.

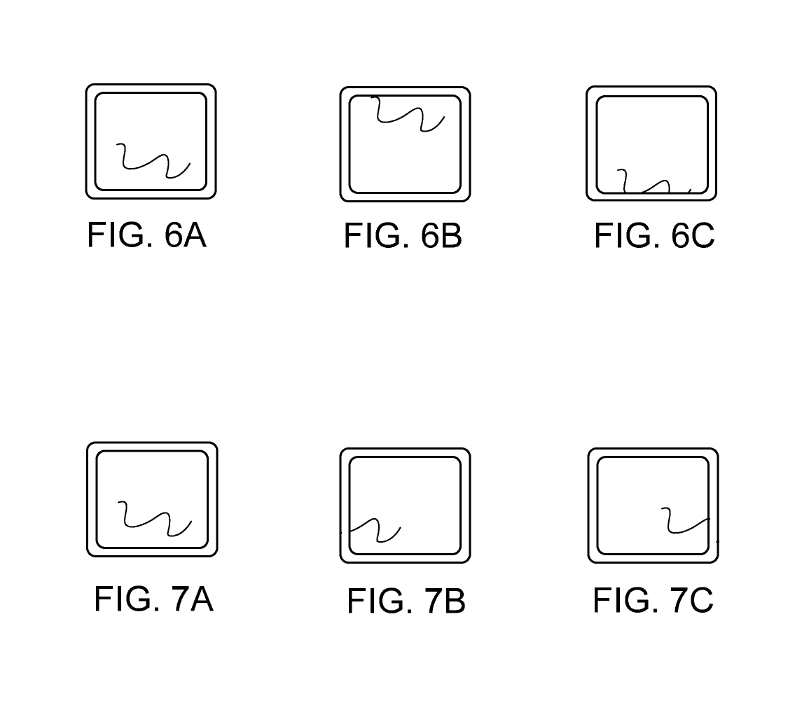

Take FIGS. 6A to 6C for example. Assume that FIG. 6A is an original display image. When the horizontal included angle at long-axis is relatively large and is greater than the first threshold of horizontal included angle, it means that the placement of the optical pen is close to the vertical direction. At this point, the display device vertically adjusts the display image according to the movement information of indicator (A).

When the user turns the roller towards the direction of the pen tail, the movement direction of indicator (a1) is defined as a positive movement direction (+), and the display image is moved upwards along the vertical direction, as shown in FIG. 6B.

A range for moving the display image upwards is determined according to the movement amount of indicator (a2). For example, when the roller turns one-half of a round towards the pen tail, contents of the display image are moved upwards by 100 pixels. When the roller turns one full round towards the pen tail, the contents of the display image are moved upwards by 200 pixels.

Similarly, when the user turns the roller towards the pen point, the movement direction of indicator (a1) is defined as a negative movement direction (−), and the display image is moved downwards, as shown in FIG. 6C. The range for moving the display image downwards along the vertical direction is determined by the movement amount of indicator (a2).

Take FIGS. 7A to 7C for example. Assume that FIG. 7A is an original display image. When the horizontal included angle at long-axis is relatively small and is smaller than the first threshold of horizontal included angle, it means that the placement of the optical pen is close to the horizontal plane. At this point, the display device horizontally adjusts the display image according to the movement information of indicator (A).

When the user turns the roller towards the pen tail, the movement direction of indicator (a1) is defined as a positive movement direction (+), and the display image is moved to the left along the horizontal direction, as shown in FIG. 7B. Further, the range of moving the display image to the left is determined according to the movement amount of indicator (a2).

Similarly, when the user turns the roller towards the pen point of the optical pen, the movement direction of indicator (a1) is defined as a negative movement direction (−), and the display image is moved to the right, as shown in FIG. 7C. Further, the range of moving the display image to the right along the horizontal direction is determined according to the movement amount of indicator (a2).

As demonstrated by the above description, the optical pen according to an embodiment of the present invention is capable of directly adjusting the display image vertically or horizontally.

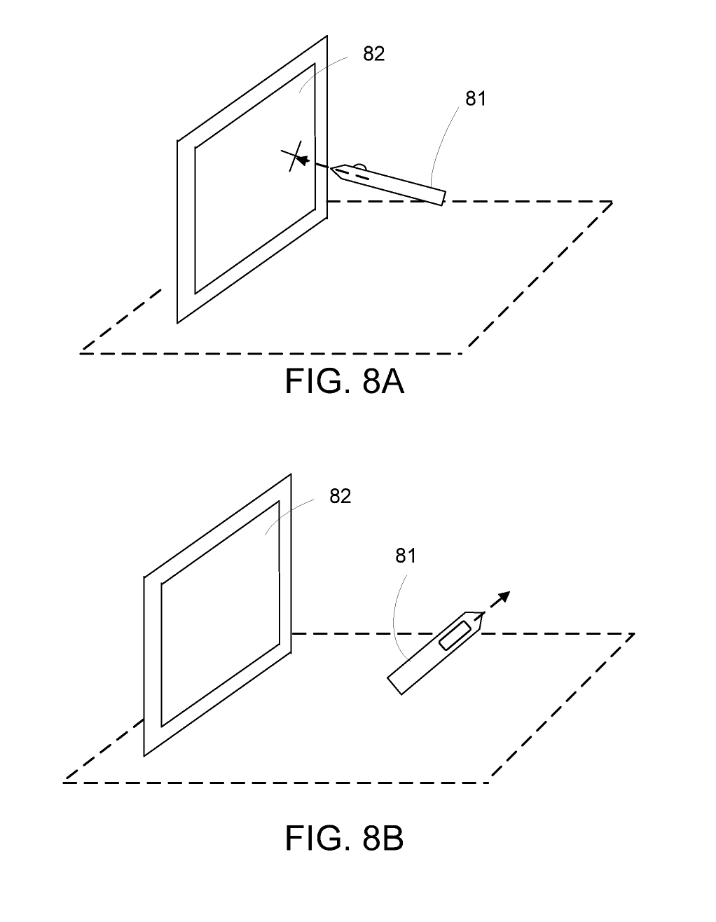

Referring to FIGS. 8A and 8B, when an indication path of an optical pen 81 points towards a display image 82, a cross-shaped cursor is displayed in the display image 82. When the indication path of the optical pen 81 is not pointing towards the display image 82, the cursor is not displayed. Thus, in the present invention, according to whether the indication path intersects the display image, the user can selectively enable the optical pen to scale up/down the display image.

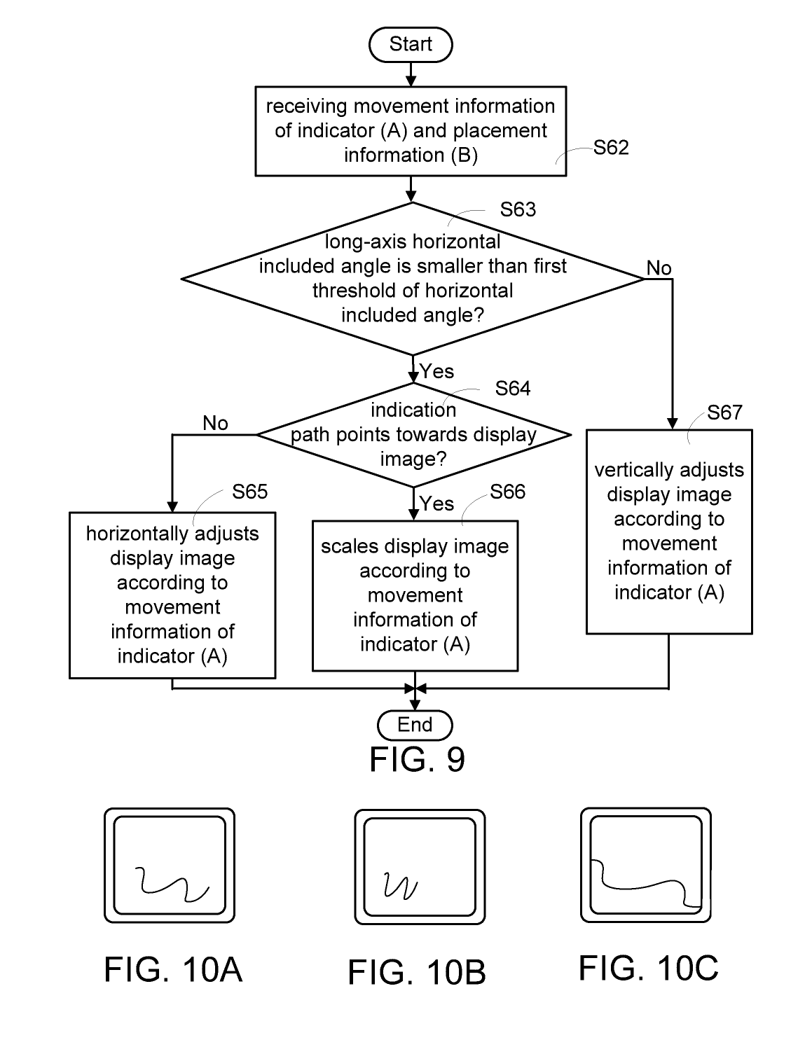

FIG. 9 shows a flowchart of a process for adjusting a display image using an optical pen according to a second embodiment of the present invention. In step S62, movement information of indicator (A) and placement information (B) outputted by an optical pen are received. In step S63, whether a horizontal included angle at long-axis is smaller than a first threshold of horizontal included angle is determined. That is, a determination step is performed according to the horizontal included angle at long-axis represented by the placement information (B).

When a determination result of step S63 is negative, the display image is vertically adjusted according to the movement information of indicator (A) in step S67. Details of the display control method in step S67 are similar to those in step S55 in FIG. 5. FIGS. 6A, 6B and 6C can be referred, and details of step S67 shall be omitted herein.

When the determination result of step S63 is affirmative, whether an indication path points towards the display image is further determined in step S64.

When the indication path does not point towards the display image, in step S65, the display device horizontally adjusts the display image according to the movement information of indicator (A). Details of the display control method in step S65 are similar to those in step S54 in FIG. 5. FIGS. 7A, 7B and 7C can be referred, and details of step S65 shall be omitted herein.

Instead, when the indication path points towards the display image, in step S66, the display device scales the display image according to the movement information of indicator (A).

Assume that FIG. 10A is an original display image. When a user rotates the roller towards the pen tail, the movement direction of indicator (a1) is defined as a positive movement direction (+), and contents of the display image are scaled down (zoom-out), as shown in FIG. 10B. Further, the display device determines a ratio for down-scaling the contents of the display image according to the movement amount of indicator (a2).

Similarly, when the user rotates the roller towards the pen point, the movement direction of indicator (a1) is defined as a negative movement direction (−), and the contents of the display image are scaled up (zoom-in), as shown in FIG. 100. Further, the display device determines a ratio for up-scaling the contents of the display image according to the movement amount of indicator (a2).

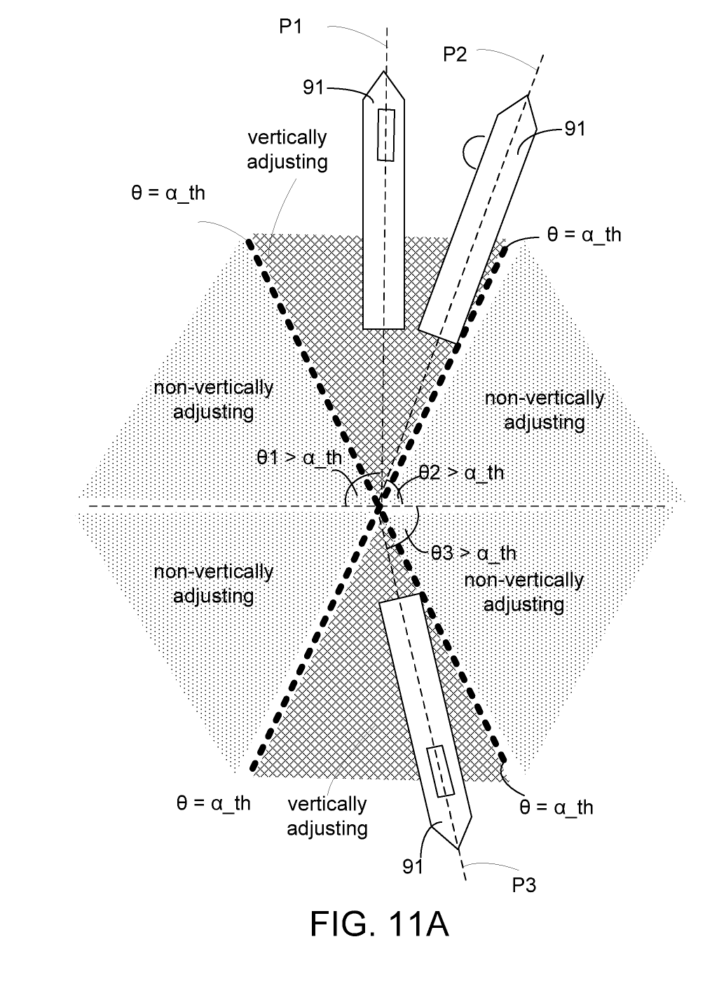

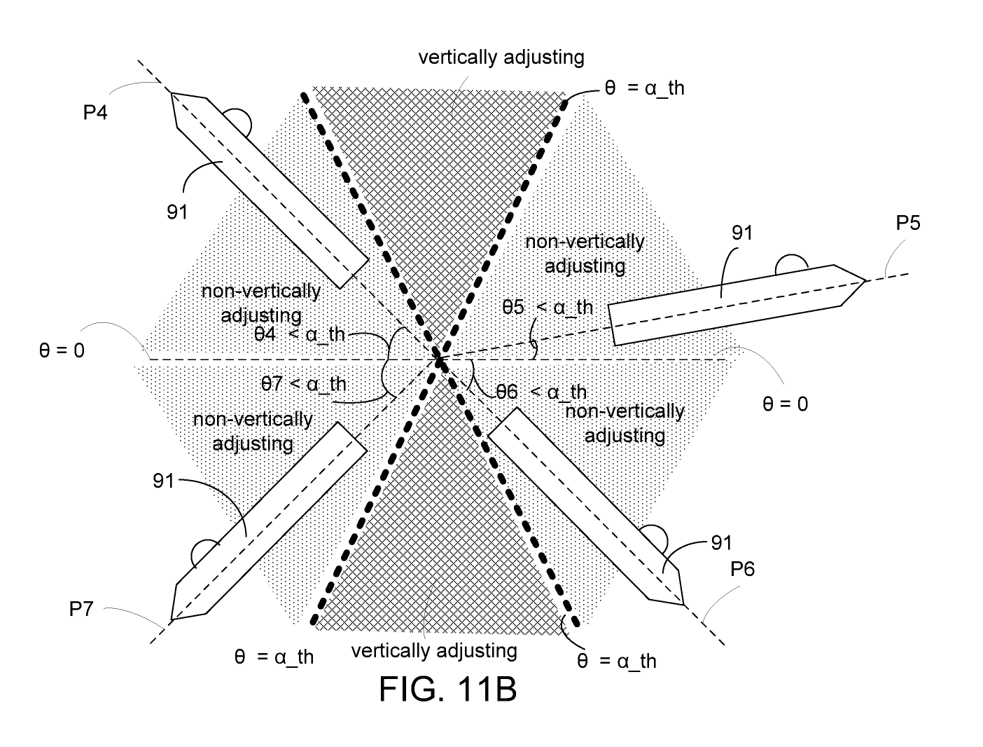

Therefore, the present invention is capable of determining the placement of the optical pen according to the long axis of the housing of the optical pen to accordingly vertically or non-vertically adjust movement of the display image. With reference to FIGS. 11A and 11B, correlation between a horizontal included angle at long-axis and a movement method of a display image is discussed. In the diagrams, the dotted line in the horizontal direction represent a direction parallel to the horizontal plane, with two thicker dotted lines representing a first threshold of horizontal included angle (α_th).

In FIG. 11A, when an optical pen 91 is respectively positioned at a first placement P1, a second placement P2 and a third placement P3, the corresponding horizontal included angles at long-axis are a first horizontal included angle at long-axis θ1, a second horizontal included angle at long-axis θ2, and a third horizontal included angle at long-axis θ3, respectively. The horizontal included angles at long-axis θ1, θ2 and θ3 are all greater than the first threshold of horizontal included angle (α_th). Therefore, when the optical pen 91 is positioned at the first placement P1, the second placement P2 and the third placement P3, the display device vertically adjust and moves the display image along the vertical direction according to the movement information of indicator.

In FIG. 11B, when the optical pen 91 is respectively positioned at a fourth placement P4, a fifth placement P5, a sixth placement P6 and a seventh placement P7, the horizontal included angles at long-axis are equivalent to a fourth horizontal included angle at long-axis θ4, a fifth horizontal included angle at long-axis θ5, a third horizontal included angle at long-axis θ6, and a seventh horizontal included angle at long-axis θ7, respectively. The horizontal included angles at long-axis θ4, θ5, θ6 and θ7 are all smaller than the first threshold of horizontal included angle (α_th). Therefore, when the optical pen 91 is postured at the fourth placement P4, the fifth placement P5, the sixth placement P6 and the seventh placement P7, the display device horizontally adjusts the display image or scales contents of the display image according to the movement information of indicator.

For example, the first threshold of horizontal included angle (α_th) may be defined as 50 degrees. When the horizontal included angle at long-axis is greater than 50 degrees, the display device adjusts the display image vertically. When the horizontal included angle at long-axis is smaller than 50 degrees, the display device adjusts the display image non-vertically.

In the present invention, the first threshold of horizontal included angle may also incorporate an error range (e.g., ±5 degrees). When a change within the error range occurs in the horizontal included angle at long-axis, the original operation mode is maintained.

For example, while the user operates the optical pen to horizontally adjust the display image, the display image is maintained if the horizontal included angle at long-axis increases from 40 degrees to 54 degrees. Only when the horizontal included angle at long-axis of the optical pen 81 continues to increase and exceeds 55 degrees, the display device then vertically adjusts the display image; and vice versa.

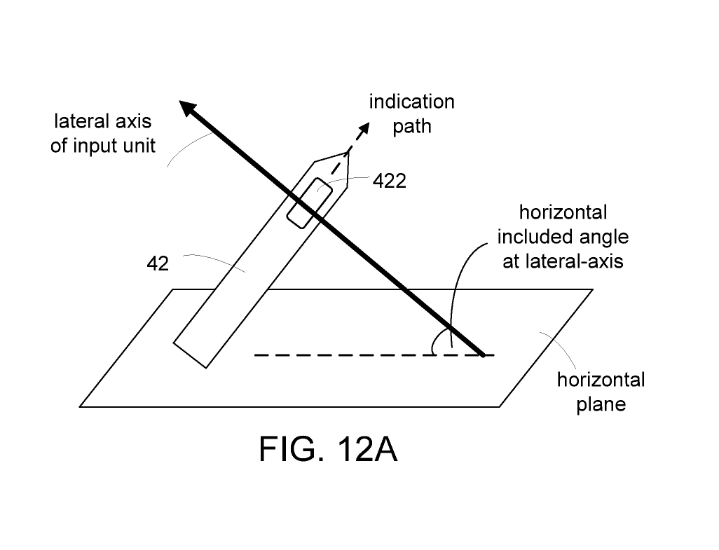

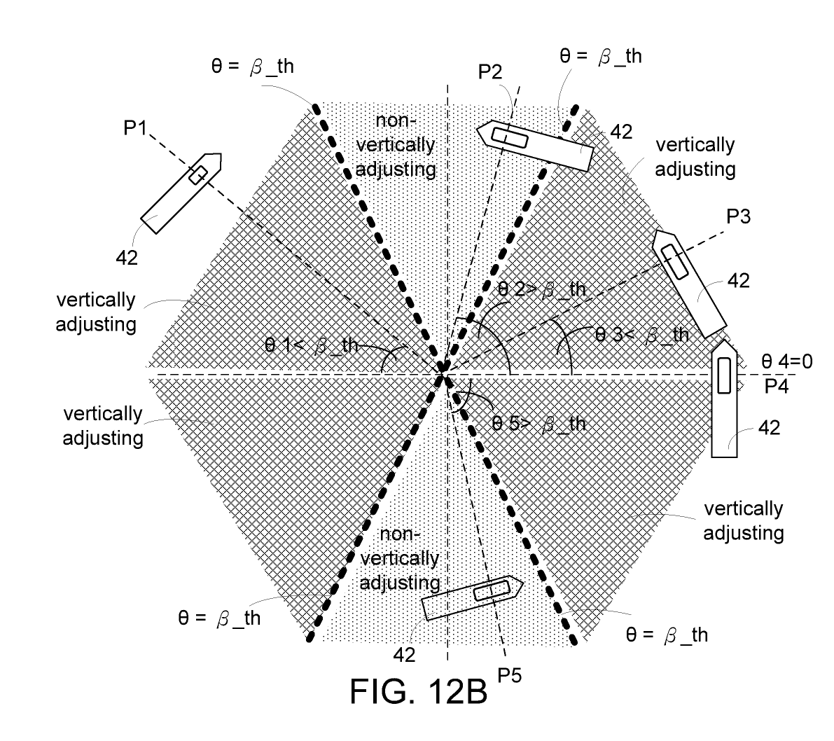

In addition to representing the placement information (B) by the horizontal included angle at long-axis, the placement information (B) may also be otherwise defined according to another embodiment of the present invention. FIG. 12A shows a schematic diagram of representing a placement of an optical pen 42 by a horizontal included angle at lateral-axis. In FIG. 12A, an extension direction of a rotation axis of a roller 422 is defined as a lateral axis of input unit. Hence, the lateral axis of input unit is perpendicular to a pen body of the optical pen 42.

The included angle between the lateral axis of input unit and the horizontal plane is defined as a horizontal included angle at lateral-axis. The horizontal included angle at lateral axis is utilized to represent the placement information (B). Similarly, by utilizing the placement information (B) cooperating with the movement information of indicator (A) represented by a rotation direction and a rotation amount of the roller 422, the display device is enabled to further control the display image.

When a change occurs in the placement of the optical pen, the horizontal included angle at lateral-axis also changes. FIG. 12B illustrates how an operation type of a user is determined based on the horizontal included angle at lateral-axis according to an embodiment of the present invention.

In FIG. 12B, it is assumed that the optical pen 42 is positioned as a first placement P1, a second placement P2, a third placement P3, a fourth placement P4, and a fifth placement P5, which correspond to a horizontal included angle at lateral-axis of a first horizontal included angle at lateral-axis θ1, a second horizontal included angle at lateral-axis θ2, a third horizontal included angle at lateral-axis θ3, a fourth horizontal included angle at lateral-axis θ4, and a fifth horizontal included angle at lateral-axis θ5, respectively.

In FIG. 12B, the horizontal included angle at lateral-axis is relatively smaller when the optical pen 42 is positioned at the first placement P1, the third placement P3, and the fourth placement P4, as shown in the diagram. That is, the horizontal included angle at lateral-axis gets smaller as the direction of the pen body of the optical pen 42 gets closer to the vertical direction. Therefore, a second threshold of horizontal included angle (θ=β_th) is defined. When the placement of the optical pen 42 is in a way that the horizontal included angle at lateral-axis is smaller than the second threshold of horizontal included angle (θ<β_th), the display device adjusts the display image vertically.

Further, the horizontal included angle at lateral-axis is relatively larger when the placement of the optical pen 42 is positioned at the second placement P2 and the fifth placement P5, as shown in the diagram. That is, the horizontal included angle at lateral-axis gets larger as the direction of the pen body of the optical pen 42 gets closer to the horizontal direction. Therefore, a second threshold of horizontal included angle (θ=β_th) is defined. When the placement of the optical pen 42 is in a way that the horizontal included angle at lateral-axis is greater than the second threshold of horizontal included angle (θ>β_th), the display device adjusts the display image non-vertically.

Thus, in FIG. 12B, light shaded areas represent areas in which the user uses the roller of the optical pen 42 to adjust the display image non-vertically. Dark shaded areas of FIG. 12B represent areas in which the the user uses the roller of the optical pen to vertically adjusts the display image. The horizontal dotted line in FIG. 12B represents that the horizontal included angle at lateral-axis is equivalent to 0 degree, and the two thick dotted lines represent the second threshold of horizontal included angle (β_th).

When the optical pen represents the placement information by the horizontal included angle at lateral-axis, details of how the display device adjusts the display image according to the rotation direction and the rotation amount of the roller can be deduced from the foregoing description, and shall be omitted herein. It should be noted that, the corresponding relationships between the display control method of the input unit and definitions of the movement amount and the movement direction of indicator are not limited to the examples described. For example, when the roller rotates towards the pen point, the movement direction of indicator may also be defined as a positive movement direction, and vice versa.

In the above embodiments, it is assumed that the input unit of the optical pen is a roller. Hence, the two directions along which the roller rotates correspond to two opposite directions of the same dimension in an indicator movement, and an actual rotation amount of the roller corresponds to the movement amount of indicator of the display image. Alternatively, the input unit of the optical pen may also be a touch pad on an X-Y plane, a rocker, or a key switch etc. The input unit extends along the Y-axis, and the X-axis is the lateral axis of the input unit.

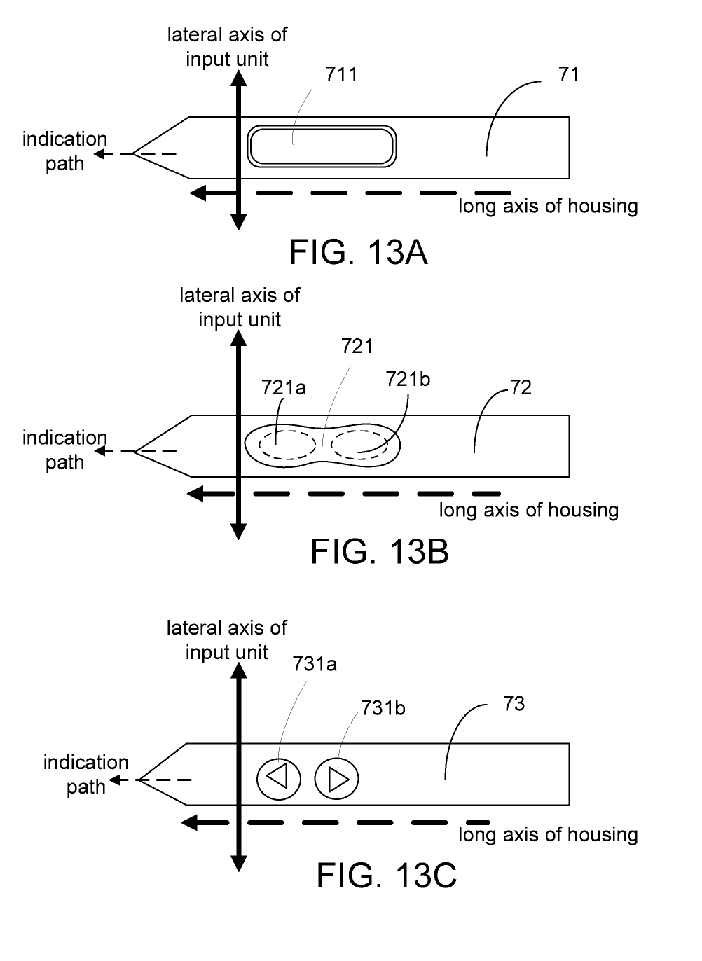

FIG. 13A shows a schematic diagram of utilizing a long touch pad 711 as an input unit of an optical pen. A long axis of the housing is defined as being parallel to a direction of a pen body of an optical pen 71, and an indication path represents a direction parallel to the long axis of the housing and pointing towards a pen point. Further, the lateral axis of input unit is defined as a direction perpendicular to the direction of the pen body of the optical pen 71.

The touch pad 711 is capable of detecting a touch gesture, whose movement direction may be selected from either a positive movement direction or a negative movement direction. When the optical pen 71 utilizes the touch pad 711 as an input unit, the movement amount and the movement direction of indicator may be represented by a movement distance and a movement direction of the touch gesture.

FIG. 13B shows a schematic diagram of utilizing a rocker 721 as an input unit of the optical pen. The long axis of the housing is defined as being parallel to a direction of the pen body of the optical pen 71, and an indication path represents a direction parallel to the long axis of the housing and pointing towards the pen point. Further, the lateral axis of input unit is defined as a direction perpendicular to the direction of the pen body of the optical pen 71.

The rocker 721 may generate a conduction signal in response to a user press. The movement amount of indicator corresponds to a pressed period or the number of presses on the rocker 721. When a position at a front half 721a of the rocker 721 close to the pen point is pressed, the positive movement direction indicates the movement direction of the indicator. When a position at a second half 721b of the rocker 721 close to the pen tail is pressed, the negative movement direction indicates the movement direction of indicator.

FIG. 13C shows a schematic diagram of utilizing a key switch 731 as an input unit of the optical pen. The long axis of the housing is defined as being parallel to a direction of the pen body of the optical pen 71, and an indication path represents a direction parallel to the long axis of the housing and pointing towards the pen point. Further, the lateral axis of input unit is defined as a direction perpendicular to the direction of the pen body of the optical pen 71.

When a pressed position is a key switch 731a closer to the pen point, it is assumed that the conduction signal is in a first state, and the movement direction of indicator at this point is defined as a positive movement direction.

When a pressed position is a key switch 731b closer to the pen tail, it is assumed that the conduction signal is in a second state, and the movement direction of indicator at this point is defined as a negative movement direction.

Apart from determining the movement direction of indicator according to the key switches 731a and 731b, the movement amount of indicator may be further determined according to the number of presses or a press period of the key switches 731a and 731b.

In another application, in addition to writing or drawing function, the optical pen further provides a function for modifying display attributes of an input trace.

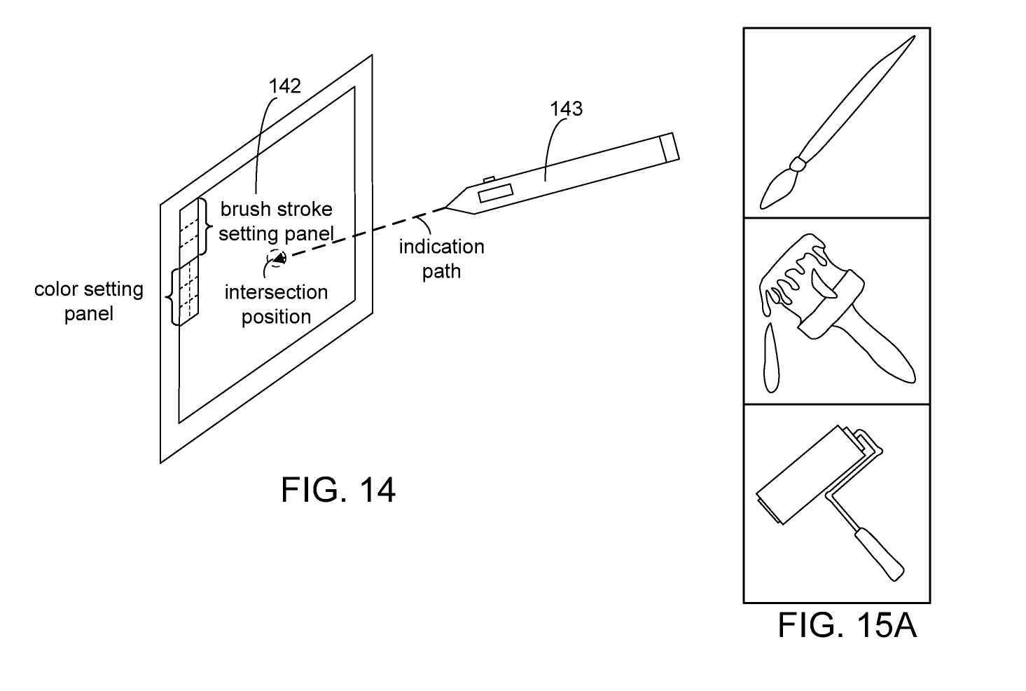

FIG. 14 shows a schematic diagram of a display system according to an embodiment of the present invention. The display device is connected to a personal computer PC, which is currently executing graphics software (e.g., mspaint in Windows accessories) that opens an image file A.

On the left side of the graphics software, there are setting panels for brush strokes and colors. A user may control a placement of an optical pen 143 in a way that an intersection position of the optical pen 143 and a display image 142 stays at the various areas at the left of the display image 142, such that the user is allowed to select a brush stroke or color of an input trace according to a desired setting type. Associated details are described below.

In addition to displaying an indication pattern at an intersection position for prompting a user, the display device may also display a brush stroke pattern as an indication pattern. The type of the brush stroke pattern is selected by an user when the user utilizes the graphics software for writing or drawing.

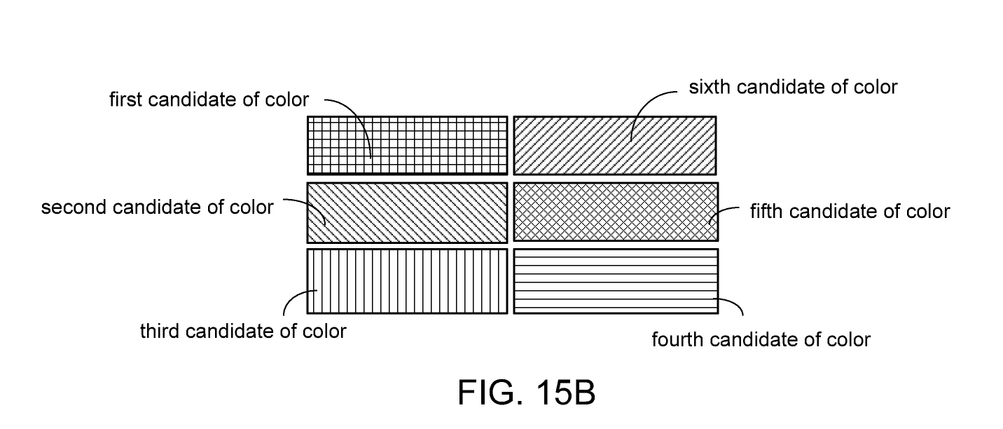

Taking FIG. 15A for example, the graphics software provides pre-selected brush stroke patterns in a brush stroke setting panel. The pre-selected brush stroke patterns may include watercolor, paint brush and tumbler etc. Assuming that the graphics software utilizes the pattern of the watercolor as a first brush stroke pattern, the pattern of the paint brush as a second brush stroke pattern, and the pattern of the tumbler as the third brush stroke pattern.

According to an embodiment of the present invention, when an intersection position stays at the brush stroke setting panel, and the user performs a dynamic operation using the optical pen (e.g., swinging the optical pen back-and-forth), the pattern of the brush stroke may correspondingly change.

For example, the first brush stroke pattern (watercolor) is selected when the optical pen is swung once, the second brush stroke pattern (paint brush) is selected when the optical pen is swung twice, and the third brush stroke pattern (tumbler) is selected when the optical pen is swung three times. Similarly, the optical pen may restore to the first brush stroke pattern (watercolor) when the user again swings the optical pen, and so forth in a cyclic manner.

In other words, instead of changing the selected brush stroke pattern from options provided by the setting panel, the display system of the present invention allows the user to change the selected brush stroke pattern through directly operating the optical pen. In the present invention, the current brush stroke pattern is selected according to whether the user swings the optical pen and the number of swing times.

To implement the above function, an acceleration sensing unit, for sensing an acceleration of movements of the pen-like housing in space, may be disposed in the optical pen. When the optical pen is dynamically swung, wavered or vibrated by the user, a vibration signal of housing is generated by the acceleration sensing unit. The vibration signal of housing is then transmitted to the display device via the transmission unit electrically connected to the acceleration sensing unit.

The reception unit of the display device is in communication with the transmission unit of the optical pen, such that the display device receives the vibration signal of housing via the reception unit. The display unit then changes an appearance of the indication pattern according to the number of times that the vibration signal of housing is received.

FIG. 15B shows a schematic diagram of six candidates of color for setting display attributes of input trace of the optical pen. Before selecting the desired color, the user may control the optical pen and keep the intersection position at the color setting panel. Then, the user can cyclically and sequentially selects six predetermined candidates of color provided by the color setting panel. In response to a dynamic operation performed on the optical pen by the user, the indication pattern and a display attribute of the input trace are changed.

That is, according to the number of times of swings of the optical pen, a color desired by the user can be selected. Similar to details for setting the brush stroke, through the number of times of swings of the optical pen, the user's desired color may be cyclically and sequentially selected. When the user finishes drawing or modifying a display image by operating the optical pen, the graphics software may store the display image.

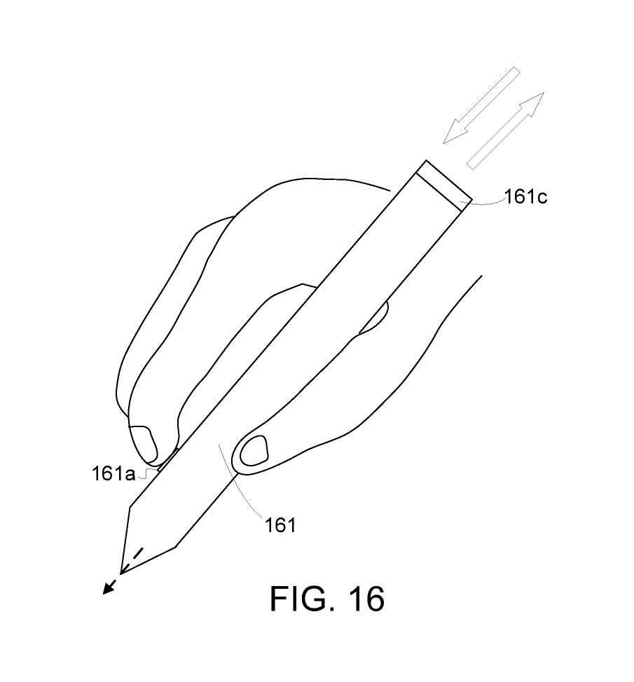

FIG. 16 shows a schematic diagram of an optical pen 161 sensing a dynamic operation of a user according to an embodiment of the present invention. A pen tail of the optical pen 161 includes a first switch unit 161c and a second switch unit 161a disposed at a side of the housing.

The first switch unit 161c is regarded as a lock unit electrically connected to the gravity sensing unit and the transmission unit.

When the user wishes to set a display attribute of the input trace, the lock unit stays inactivated, and the acceleration sensing unit continues sensing the dynamic operation of the user. That is, the display attribute of the input trace is determined according to the area where the intersection position stays and the number of swing times performed by the user.

Once the user determines the brush stroke and the color of the input trace, the first switch unit 161c may be pressed. At this point, the lock unit is activated, meaning that the optical pen 161 no longer detects the dynamic operation made by the user. When the lock unit is activated and a lock signal is generated, the acceleration sensing unit also stops outputting the vibration signal of housing.

When the user again wishes to change the display attribute of the input trace after having written for a period, the first switch unit 161c may again be pressed, i.e., to terminate the activation of the lock unit. The above selection setting process may be repeated, and the lock unit may be re-activated after the selection process is completed.

The second switch unit 161a is regarded as an enable unit electrically connected to the transmission unit, and generates an enable signal in response to a user operation.

When the enable unit is pressed, the enable unit generates an enable signal, which is transmitted to the display device. When the enable unit is pressed, it means that the user wishes to set the graphics software to a writing mode. That is to say, in addition to adjusting position of the indication pattern in response to a change in the intersection position, the input trace is also correspondingly modified.

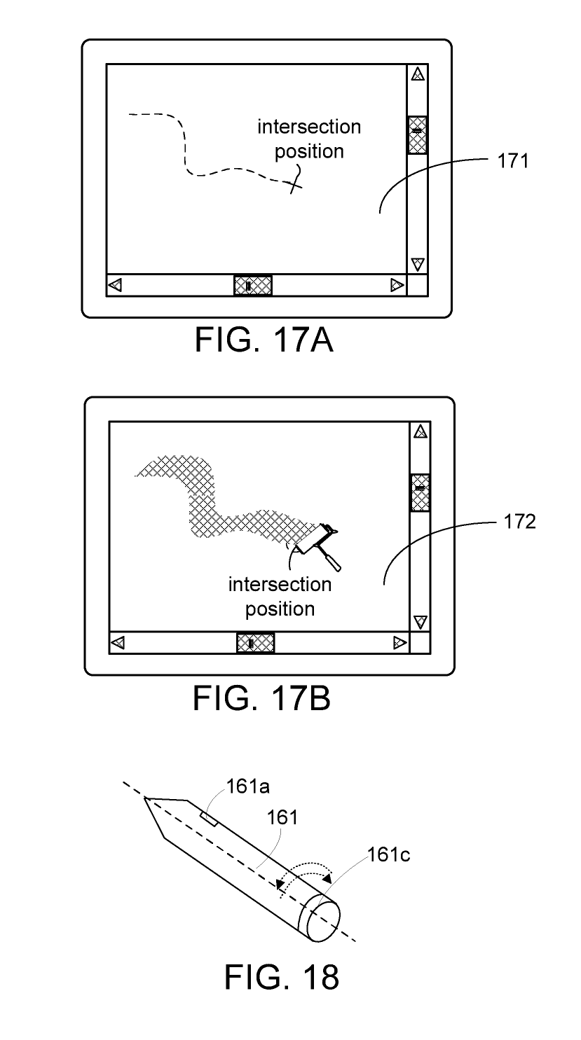

FIG. 17A shows an operation of the graphics software in a non-writing mode when the enable unit is not pressed. At this point, the display device displays a current intersection position using the indication pattern. In FIG. 17A, the dotted line represents a continuous movement process of the intersection position. Such dotted trace is neither displayed in a display image 171 nor recorded to a currently open image file by the graphics software.

FIG. 17B shows an operation of the graphics software in a writing mode when the enable unit is pressed. At this point, apart from displaying the indication pattern, the display device also displays a trace representing the change in the intersection position. Assume that the user selects the third brush stroke pattern (tumbler) and the first candidate of color. In FIG. 17B, the solid trace represents a continuous movement process of the intersection position. Referring to FIG. 17B, a display image 172 displays a thicker solid trace; the graphics software modifies and edits the currently open image file according to the above solid trace, and records the solid trace to the currently open image file.

In the foregoing preferred embodiments, the graphics software determining how to change the input trace according to the back-and-forth swings of the optical pen is given as an example. In practice, the type of dynamic operation sensed by the optical pen is not limited to the given example of back-and-forth swings. Other movements such as rotations and vibrations may also serve as a determination basis for the optical pen to generate the vibration signal of housing.

Further, after the user determines the brush stroke or color (e.g., the third brush stroke pattern and the first candidate of color) and presses the enable unit to enter the writing mode, changes in a width and a brightness level of the input trace may also be determined according to a rotation of the pen body. Associated details are given as below.

FIG. 18 shows a schematic diagram of sensing a rotation range of the optical pen. In FIG. 18, a central axis of the optical pen 161 can be regarded as a rotation center, with the optical pen 161 being rotated clockwise or counterclockwise. According to the range that the user rotates the optical pen 161, the width, color or brightness level settings of the input trace may be determined.

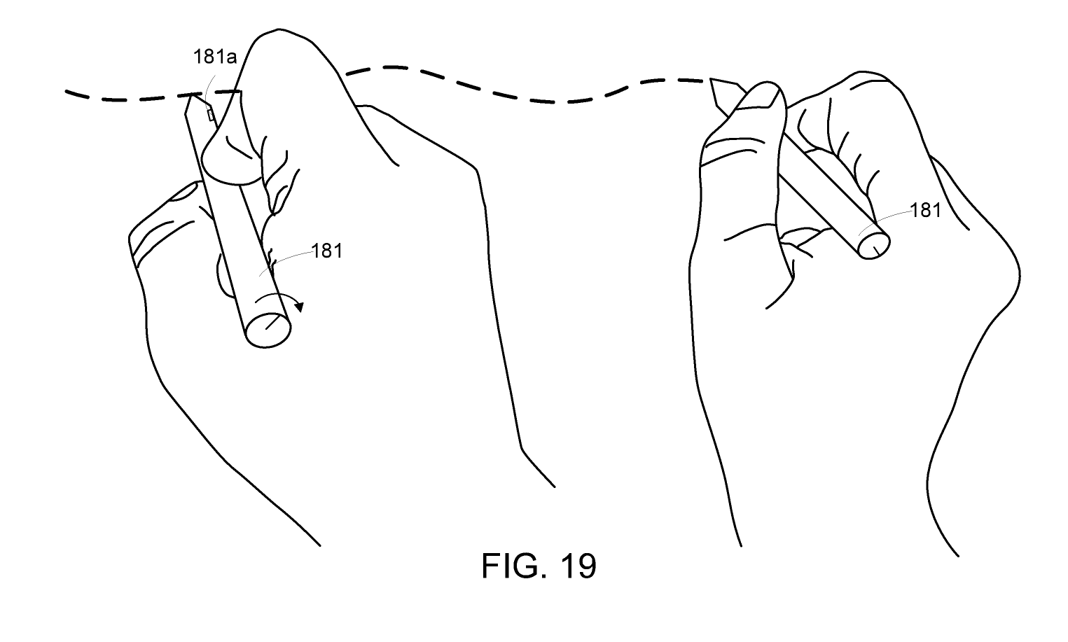

FIG. 19 shows a schematic diagram of the optical pen being rotated by the user. For example, when the user operates an optical pen 181 to draw a dotted trace as shown FIG. 19, the user also rotates the optical pen 181 by regarding the central axis of the optical pen 181 as a rotation center while moving the optical pen 181 from left to right. Thus, a second switch unit 181a, originally displayed towards an upper part of the diagram, has been moved to a lower part of the diagram when the optical pen was moved from the left to the right of the dotted line.

The present invention further provides a method for adjusting the width setting of the input trace by rotating of the optical pen during a writing process. Associated details are given as below.

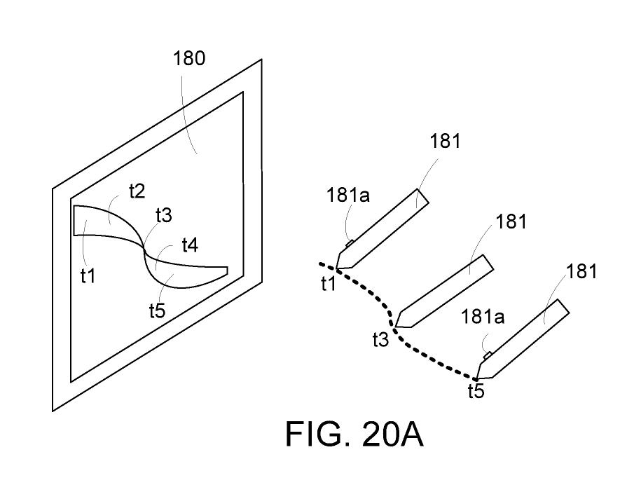

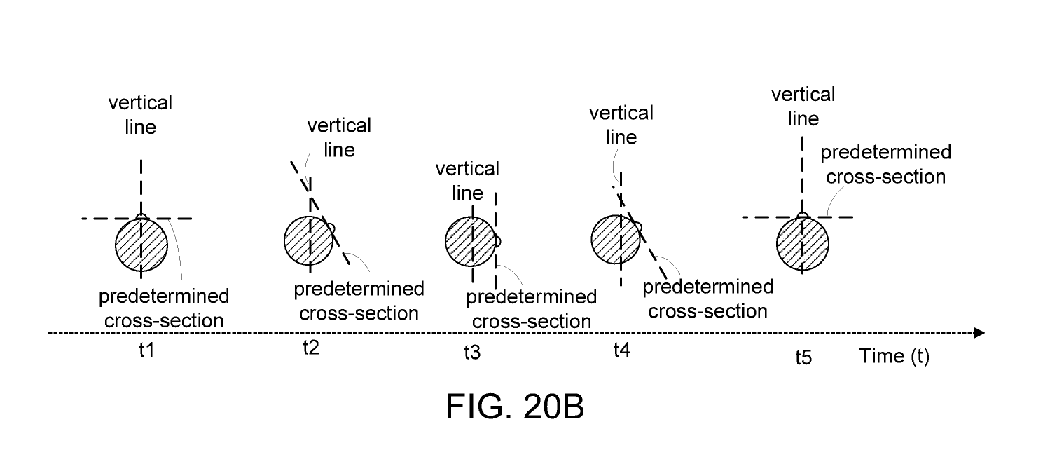

FIG. 20A shows a schematic diagram of different widths corresponding to an input trace by rotating the optical pen.

Assume that the user writes a horizontal S trace by operating the optical pen 181. It is also assumed that, in addition to moving the optical pen 181 along the dotted line in the diagram when the position of the optical pen 181 is postured in a three-dimensional space, the rotation direction of the pen body of the optical pen 181 also changes at different time points when the user operates the optical pen 181.

As seen from the diagram, when the user operates the optical pen 181, the width of the input trace displayed in the display image is synchronously adjusted. For example, corresponding to rotation directions of the optical pen 181 at time points t1, t3 and t5, the width of the input trace displayed in a display image 180 becomes thicker, narrower and thicker, respectively.

FIG. 20B shows a cross-section of the optical pen corresponding to different time points during a writing process in FIG. 20A.

To distinguish rotation statuses of the optical pen at different time points, it is assumed that a predetermined cross-section is a cross-section of the enable unit of the optical pen at a position on the surface of the optical pen. The predetermined cross-section may be defined according to another method. For example, the predetermined cross-section may be defined as a cross-section of the roller of the optical pen on a position of the surface of the optical pen. Further, in the embodiment, an included angle between the predetermined cross-section of the optical pen 181 and the vertical line is defined as a vertical included angle.

At the first time point t1, when viewing the cross-section of the optical pen 181 from a rear side of the optical pen 181, the enable unit 181a is located at a position relative to an upper part of the optical pen 181. At this point, the vertical included angle between the predetermined cross-section of the optical pen 181 and the vertical line is 90 degrees. It is assumed that width of the input trace is thicker when the vertical included angle is 90 degrees. For example, the width of the input trace at the first time point t1 is set to a display ratio of 100%.

At the second time point t2, when viewing the cross-section of the optical pen 181 from the rear side of the optical pen 181, the enable unit is located at a position relative to an upper-right part of the optical pen 181. At this point, the vertical included angle between the predetermined cross-section of the optical pen 181 and the vertical line is 45 degrees. The width of the input trace at the second time point t2 may be set to a reduced display ratio of 75%.

At the third time point t3, when viewing the predetermined cross-section of the optical pen 181 from the rear side of the optical pen 181, the enable unit is located at a position relative to a right part of the optical pen 181. At this point, the vertical included angle between the predetermined cross-section of the optical pen 181 and the vertical line is 0 degree. The width of the input trace at the third time point t3 may be set to a reduced display ratio of 50%.

At the fourth time point t4, when viewing the predetermined cross-section of the optical pen 181 from the rear side of the optical pen 181, the enable unit is located at a position relative to the upper-right part of the optical pen 181. At this point, the vertical included angle between the predetermined cross-section of the optical pen 181 and the vertical line is 45 degrees. The width of the input trace at the third time point t3 may be restored to a display ratio of 75%.

At the fifth time point t5, when viewing the predetermined cross-section of the optical pen 181 from the rear side of the optical pen 181, the enable unit 181a is located at a position relative to the upper part of the optical pen 181. At this point, the vertical included angle between the predetermined cross-section of the optical pen 181 and the vertical line is restored to 90 degrees such that the width of the input trace in the display image again becomes thicker. The width of the input trace at the fifth time point t5 may be restored to a display ratio of 100%.

The optical pen of the present invention may utilize the gravity sensing unit to sense the vertical included angle to obtain information of vertical included angle, and transmit the information of vertical included angle to the display device through the transmission unit. The display device receives the information of vertical included angle through the reception unit, and provides the information of vertical included angle to the graphics software at the personal computer end. Accordingly, the graphics software at the personal computer end may adjust the display attribute of the input trace with reference to the received information.

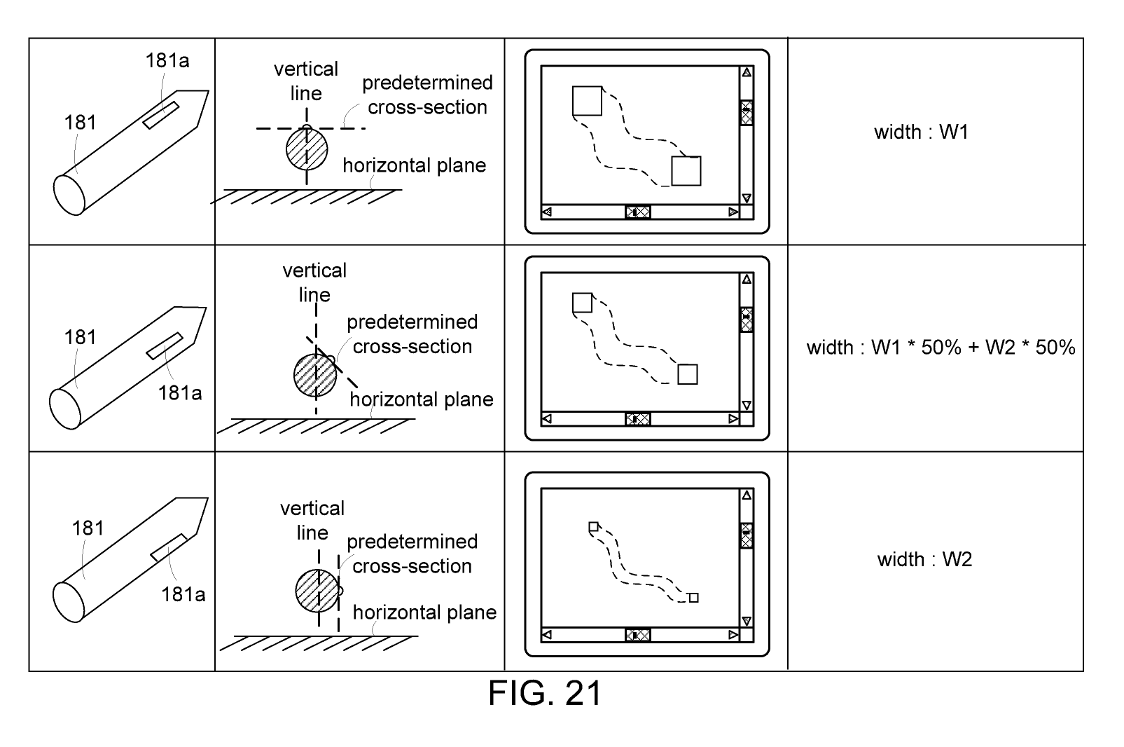

FIG. 21 shows a schematic diagram of how a change in the included angle between the predetermined cross-section of the optical pen and the vertical line affects width setting of the input trace.

In FIG. 21, the first column represents the placement of the optical pen when viewing forward from a rear side end of the optical pen 181. The second column represents a relationship between the vertical line and the predetermined cross-section for different placements of the optical pen 181 when viewing forward from a rear end of the optical pen 181. The third column illustrates the input trace when the width changes. The fourth column represents how to calculate the width of the input trace according to the vertical included angle.

Assuming that settings of the graphics software are that, the width of the input trace is equivalent to a first width W1 when the vertical included angle of the optical pen 181 is equivalent to a first predetermined angle θ1, and is equivalent to a second width W2 when the vertical included angle is equivalent to a second predetermined angle θ2.

When the user operates the optical pen 181, a first angle difference Δθ1 exists between the vertical included angel of the optical pen 181 and the first predetermined angle θ1, and a second angle difference Δθ2 exists between the vertical included angel of the optical pen 181 and the second predetermined angle θ2. A width W of the input trace is jointly determined according to the first width W1, the second width W2, the first angle difference Δθ1, and the second angle difference Δθ2. For example:

$$W = W 1 * \frac{\vert θ - θ2 \vert}{\vert θ2 - θ1 \vert} + W 2 * \frac{\vert θ - θ1 \vert}{\vert θ2 - θ1 \vert} = W 1 * \frac{Δθ2}{\vert θ2 - θ1 \vert} + W 2 * \frac{Δθ1}{\vert θ2 - θ1 \vert}$$

In the first row of FIG. 21, it is assumed that, when viewing from the pen tail towards the pen point of the optical pen 181, the first placement of the optical pen 181 renders the enable unit to be relatively positioned at a twelve o'clock position, meaning that the included angle between the predetermined cross-section and the vertical line is 90 degrees. At this point, with the 90-degree first predetermined angle, the first angle difference Δθ1 is equivalent to 0 degree, and the second angle difference Δθ2 is equivalent to 90 degrees. When the optical pen 181 is positioned at such placement, the input trace corresponding to the optical pen 181 has the first width W1. That is,

$$W = W 1 * \frac{Δθ2}{\vert θ2 - θ1 \vert} + W 2 * \frac{Δθ1}{\vert θ2 - θ1 \vert} = W 1 * \frac{90}{90} + W 2 * \frac{0}{90} = W 1$$

On the other hand, in the third row in FIG. 21, the second placement of the optical pen 181 renders the enable unit to be relatively positioned at a three o'clock position, meaning that the included angle between the predetermined cross-section and the vertical line is 0 degree. At this point, with the 0-degree second predetermined angle, the first angle difference Δθ1 is 90 degrees and the second angle difference Δθ2 is 0 degree. When the optical pen 181 is positioned at such placement, the input trace corresponding to the optical pen 181 has the second width W2. That is,

$$W = W 1 * \frac{Δθ2}{90} + W 2 * \frac{Δθ1}{90} = W 1 * \frac{0}{90} + W 2 * \frac{90}{90} = W 2$$

Further, in the second row of FIG. 21, the direction of the optical pen 181 renders the placement of the optical pen 181 to be between the first row and the third row. At this point, the width of the input trace is between the first width W1 and the second width W2.

For example, when the vertical included angle is 45 degrees, the corresponding width of the input trace of the optical pen is determined as below.

$$W = W 1 * \frac{\vert 45 - 0 \vert}{\vert 0 - 90 \vert} + W 2 * \frac{\vert 45 - 90 \vert}{\vert 0 - 90 \vert} = W 1 * \frac{45}{90} + W 2 * \frac{45}{90} = W 1 * 50 \% + W 2 * 50 \%$$

Further, setting of the brightness level or color of the input trace may also be similarly obtained.

For example, when the vertical included angle is 90 degrees, the corresponding brightness level of the input trace is assumed to be a first brightness level L1. When the vertical included angle is 0 degree, the corresponding brightness level of the input trace is assumed to be a second brightness level L2. It is also assumed that the first brightness level L1 is brighter than the second brightness level L2.

Accordingly, when the vertical included angle is 30 degrees, the corresponding brightness level of the input trace is represented in following equation.

$$L = L 1 * \frac{\vert 30 - 0 \vert}{\vert 0 - 90 \vert} + L 2 * \frac{\vert 30 - 90 \vert}{\vert 0 - 90 \vert} = L 1 * \frac{30}{90} + L 2 * \frac{60}{90} = L 1 * \frac{1}{3} + L 2 * \frac{2}{3}$$

That is, different display attributes (e.g., the brightness level, color and width) may be adjusted using the vertical included angle, and the predetermined angle corresponding to different display attributes may be different or the same. Associated details can be easily understood and modified by a person having ordinary skill in the art, and shall be omitted herein.

Apart from the width of the input trace, such approach of changing settings according to the rotation of the roller may also be applied to the brightness level and color settings of the optical pen.

Therefore, according to a preferred embodiment of the present invention, when the user operates the optical pen for writing, the display attribute of the input trace may be changed according to the direction of the rotation axis of the optical pen. Instead of obtaining the display attributes of the input trace through calculation, the display attributes of the input trace may also be obtained through a look-up table (LUT). Associated details can be easily understood and deduced by a person having ordinary skill in the art, and shall be omitted herein.

Similarly, the optical pen according to an embodiment of the present invention may further include a lock unit. When the lock unit is inactivated, a lock signal is not generated. In such case, the gravity sensing unit continues to sense the vertical included angle to update the included angle information. When the lock unit is activated, the lock signal is correspondingly generated. With the generation of the lock signal, contents of the information of vertical included angle is maintained as that is last updated by the gravity sensing unit before the lock unit is activated.

In conclusion, in the present invention, associated display settings of the display device can be adjusted through various operation methods and placements of the optical pen, thereby offering enhanced ease-of-use to the operations of the display system.

It should be noted that, the display system may include a plurality of remote control devices, each of which has corresponding identity. Input traces corresponding to the remote control devices may be provided, with each of input traces having distinctive brush stroke, size, width, color and brightness level settings. Details for applying the display system with multiple remote control devices are known to a person having ordinary skill in the art, and shall be omitted herein.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A display system, comprising:
a remote control device, comprising:
a housing, having a predetermined cross-section, wherein an indication path is extended from the housing;
a gravity sensing unit, for sensing a vertical included angle between the predetermined cross-section and a vertical line to obtain an information of vertical included angle; and
a transmission unit, electrically connected to the gravity sensing unit, for transmitting the information of vertical included angle; and
a display device, comprising:
a reception unit, in communication with the transmission unit, for receiving the information of vertical included angle;
a display unit, for displaying a display image, in which the indication path is pointed toward an intersection position, and an indication pattern is displayed at the intersection position, wherein an appearance of the indication pattern changes according to the information of vertical included angle.

2. The display system according to claim 1, wherein the remote control device further comprises:
an enable unit, electrically connected to the transmission unit, for generating an enable signal in response to an user operation;
wherein, the display unit displays an input trace in response to a change of the intersection position when the enable signal is generated, and adjusts position of the indication pattern in response to the change of the intersection position when the enable signal is not generated.

3. The display system according to claim 1, wherein the indication pattern is a brush stroke pattern and the display device further comprises:
graphics software, for generating an input trace of the brush stroke pattern on the display image, wherein one of size, width, color, and brightness level settings of the input trace changes in response to a change of the vertical included angle.

4. The display system according to claim 3, wherein the display device further comprises:
a storage unit, electrically connected to the display unit, for storing the input trace and one of the size, width, color, and brightness level settings of the input trace.

5. The display system according to claim 3, wherein the width of the input trace changes in response to the change of the vertical included angle,
when the vertical included angle is a first predetermined angle, the width of the input trace is a first width; and
when the vertical included angle is a second predetermined angle, the width of the input trace is a second width, wherein the first width is greater than the second width.

6. The display system according to claim 5, wherein a first angle difference exists between the vertical included angle and the first predetermined angle, and a second angle difference exists between the vertical included angle and the second predetermined angle, wherein the width of the input trace is jointly determined according to the first width, the second width, the first angle difference, and the second angle difference.

7. The display system according to claim 3, wherein the brightness level of the input trace changes in response to the change of the vertical included angle,
when the vertical included angle is a third predetermined angle, the brightness level of the input trace is a first brightness level; and
when the vertical included angle is a fourth predetermined angle, the brightness level of the input trace is a second brightness level, wherein the first brightness level is greater than the second brightness level.

8. The display system according to claim 7, wherein a third angle difference exists between the vertical included angle and the third predetermined angle, and a fourth angle difference exists between the vertical included angle and the fourth predetermined angle, wherein the width of the input trace is jointly determined according to the first brightness level, the second brightness level, the third angle difference, and the fourth angle difference.

9. The display system according to claim 3, wherein the color of the input trace changes in response to the change of the vertical included angle,
when the vertical included angle is a fifth predetermined angle, the color of the input trace is a first color; and
when the vertical included angle is a sixth predetermined angle, the color of the input trace is a second color, wherein the first color is different from the second color.

10. The display system according to claim 9, wherein a fifth angle difference exists between the vertical included angle and the fifth predetermined angle, and a sixth angle difference exists between the vertical included angle and the sixth predetermined angle, wherein the color of the input trace is jointly determined according to the first color, the second color, the fifth angle difference, and the sixth angle difference.

11. The display system according to claim 1, wherein the remote control device further comprises:
a lock unit, electrically connected to the gravity sensing unit and the transmission unit, for generating a lock signal, wherein,
when the lock unit is inactivated, the gravity sensing unit continuously senses the vertical included angle to update the information of vertical included angle; and
when the lock unit is activated, the information of vertical included angle is maintained as that is last updated by the gravity sensing unit before the lock unit is activated.

12. A remote control device, in communication with a display device, wherein the display device displays a display image, in which an indication path is pointed toward an intersection position, and an indication pattern is displayed at the intersection position, wherein an appearance of the indication pattern changes according to an information of vertical included angle, wherein the remote control device comprises:
a housing, having a predetermined cross-section, wherein the indication path is extended from the housing;
a gravity sensing unit, for sensing a vertical included angle between the predetermined cross-section and a vertical line to obtain the information of vertical included angle; and
a transmission unit, electrically connected to the gravity sensing unit, for transmitting the information of vertical included angle to the display device.

13. The remote control device according to claim 12, wherein the indication pattern is a brush stroke pattern, and the display device further comprises:
graphics software, for representing a change in the intersection position using an input trace, wherein one of size, width, color, and brightness level settings of the input trace changes in response to a change of the vertical included angle.

14. A display method, applied between a remote control device and a display device that are in communication with each other, the display method comprising steps of:
sensing a vertical included angle between a predetermined cross-section of the remote control device and a vertical line to obtain an information of vertical included angle, wherein an indication path is extended from the remote control device;
transmitting the information of vertical included angle to the display device; and
displaying a display image, wherein the indication path is pointed to an intersection position in the display image, an indication pattern is displayed at the intersection position, and an appearance of the indication pattern changes according to the information of vertical included angle.

15. The display method according to claim 14, further comprising steps of:
generating an enable signal in response to an user operation,
transmitting an input signal to the display device in response to generation of the enable signal, wherein,
the display device displays the indication pattern at the intersection position when the input signal is received, and
the display device stops displaying the indication pattern at the intersection position when the input signal is not received.

16. The display method according to claim 14, wherein the indication pattern is a brush stroke pattern, and the display device further comprises:
graphics software, for generating an input trace of the brush stroke pattern on the display image, wherein one of size, width, color, and brightness level settings of the input trace changes in response to a change of the vertical included angle.

17. The display method according to claim 14, further comprising steps of:
generating a lock signal, wherein
when the lock signal is not generated, the remote control device continuously senses the vertical included angle to update the information of vertical included angle; and
when the lock signal is generated, the information of vertical included angle is maintained as that is last updated by the remote control device before the lock signal is generated.
